(19) United States
(12) Patent Application Publication
(10) Pub. No.: US 2008/0263287 A1
(43) Pub. Date: Oct. 23, 2008

(54) MULTI-PORT MEMORY DEVICE AND COMMUNICATION SYSTEM HAVING THE SAME

(75) Inventor: Youn-Cheul KIM, Seoul (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 12/100,967

(22) Filed: Apr. 10, 2008

(30) Foreign Application Priority Data
Apr. 18, 2007 (KR) 2007-37662

(51) Int. Cl. G06F 12/00

(52) U.S. Cl. 711/149; 711/E12.001

(57) ABSTRACT

A communication system includes a first processor, a second processor, and a multi-port memory device. The multi-port memory device generates a first internal clock signal having a first frequency and a second internal clock signal having a second frequency based on an external clock signal. The multi-port memory device communicates with the first processor in a parallel interface mode synchronously with the first internal clock signal. In addition, the multi-port memory device communicates with the second processor in a serial interface mode synchronously with the second internal clock signal. Therefore, the multi-port memory device applied to the communication system may reduce a number of pins and costs.

### CROSS-REFERENCE TO RELATED APPLICATIONS

This application claims priority under 35 USC §119 to Korean Patent Application No. 2007-37662, filed on Apr. 18, 2007 in the Korean Intellectual Property Office (KIPO), the disclosure of which is incorporated herein in its entirety by reference.

### BACKGROUND OF THE INVENTION

1. Field of the Invention

This disclosure relates to communication between processors, and more particularly to a multi-port memory device for communicating with processors in serial and parallel interface modes, and a communication system having the multi-port memory device.

2. Description of the Related Art

Recently, a communication system or a computer system generally includes at least one processor that performs its own functions. For example, in a portable communication system, a baseband processor is included to process communication data and an application processor is included to process data for pictures or movies.

FIG. 1 is a block diagram illustrating a conventional portable communication system. Referring to FIG. 1, a portable communication system 10 includes a baseband processor 11 and an application processor 12. The baseband processor 11 processes signals received from an antenna 17. The application processor 12 controls multimedia devices.

The baseband processor 11 controls a communication modem, a digital signal processor (DSP), and a coder-decoder (CODEC). The baseband processor 11 exclusively uses a NOR-type flash memory device 13 and a mobile dynamic random access memory (MDRAM) 14 having relatively small capacity for rapid processing. The application processor 12 includes a device driver for controlling various input-output (I/O) devices and the multimedia devices. The application processor 12 exclusively uses a NAND-type flash memory device 16 and a mass storage mobile (MDRAM) 15 having relatively large capacity for processing large amount of data.

The conventional portable communication system illustrated in FIG. 1 includes the memory devices 13, 14, 15, and 16. The memory devices 13 and 14 connected to the baseband processor are exclusively used for the baseband processor 11, and the memory devices 14 and 15 are exclusively used for the application processor 12. Therefore, the portable communication system 10 has disadvantages in size, power consumption and manufacturing cost.

To solve such problems, one memory device may be shared by both the baseband processor 11 and the application processor 12.

FIG. 2 is a block diagram illustrating another conventional portable communication system, which is disclosed in US Patent Application Publication No. 2003/0093628. Referring to FIG. 2, a portable communication system 100 includes a first processor 170, a second processor 180, and a memory device 130. The memory device 130 stores data and instructions output from the processors 170 and 180. The memory device 130 is divided into three parts 131, 132, and 133. The part 133 of the memory device 130 is exclusively used for the first processor 170, and only the first processor 170 may access the part 133 of the memory device 130. In the same way, the part 131 of the memory device 130 exclusively used for the second processor 180, and only the second processor 180 may access the part 131 of the memory device 130. Both the first processor 170 and the second processor 180 may access the part 132 of the memory device 130. For example, while the first processor 170 reads data from the part 132 of the memory device 130, the second processor 180 may write data to the part 132 of the memory device 130.

In the conventional system 100, the processors 170 and 180 can access the memory device in the same interface type.

### SUMMARY OF THE INVENTION

Accordingly, embodiments of the invention substantially obviate one or more problems due to limitations and disadvantages of the related art.

Some embodiments of the invention provide a communication system, in which a multi-port memory device may communicate with processors in different interfaces.

Some embodiments of the invention provide a multi-port memory device capable of communicating with processors in different interfaces.

Some embodiments of the invention provide a method of communicating between a multi-port memory device and processors in different interfaces.

In some example embodiments of the invention, a communication system includes a first processor, a second processor, and a multi-port memory device. The multi-port memory device communicates with the first processor in a parallel interface mode synchronously with a first internal clock signal. The multi-port memory device communicates with the second processor in a serial interface mode synchronously with a second internal clock signal. The multi-port memory device generates both the first internal clock signal and the second internal clock signal based on an external clock signal.

In some embodiments, frequencies of the first internal clock signal and the second internal clock signal may be determined in response to a mode register set (MRS) signal.

In some embodiments, the second internal clock signal may have higher frequency than the first internal clock signal.

In some embodiments, the first internal clock signal and the second internal clock signal may have substantially the same frequency.

In some embodiments, the first processor may be a baseband processor and the second processor may be an application processor.

In some example embodiments of the invention the multi-port memory device includes a memory core, a clock generator, a first port, and a second port. The clock generator generates both the first internal clock signal and the second internal clock signal based on the external clock signal. The first port communicates with the first processor in the parallel interface mode synchronously with the first internal clock signal, the first port receives first data from the memory core to provide the first data to the first processor and receives first packet data from the first processor to provide the first packet data to the memory core. The second port communicates with the second processor in the serial interface mode synchronously with the second internal clock signal, the second port receives second data from the memory core to provide the second data to the second processor and receives second packet data from the second processor to provide the second packet data to the memory core.

In some embodiments, the second internal clock signal may have higher frequency than the first internal clock signal.

In some embodiments, the memory core may include a first part exclusively accessed by the first port and a second part exclusively accessed by the second port.

In some embodiments, each of the first port and the second port may access an entire range of the memory core.

In a method of communicating between a multi-port memory device and processors according to some example embodiments of the invention, a first internal clock signal having a first frequency is generated based on an external clock signal. A second internal clock signal having a second frequency is generated based on the external clock signal. A multi-port memory device communicates with the first processor in a parallel interface mode synchronously with the first internal clock signal. The multi-port memory device communicates with a second processor in a serial interface mode synchronously with the second internal clock signal.

In communicating between the first processor and the multi-port memory device, the multi-port memory device may provide first data to the first processor in the parallel interface mode synchronously with the first internal clock signal. First packet data may be received from the first processor in the parallel interface mode. Then, the multi-port memory device may provide the first packet data to the memory core synchronously with the first clock signal. The multi-port memory device may provide second data to the second processor synchronously with the second internal clock signal. Second packet data may be received from the second processor in the serial interface mode. Then, the multi-port memory device may provide the second packet data to the memory core synchronously with the second internal clock signal.

Consequently, in the communication system according to the example embodiment of the present invention, the multi-port memory device may communicate with the processors in different interface modes. The multi-port memory device applied to the communication system may reduce the number of pins and manufacturing costs.

### BRIEF DESCRIPTION OF THE DRAWINGS

FIG. 1 is a block diagram illustrating a conventional portable communication system.

FIG. 2 is a block diagram illustrating another conventional portable communication system.

FIG. 3 is a block diagram illustrating a communication system according to an example embodiment of the present invention.

FIG. 4 is a block diagram illustrating an example embodiment of the dynamic random access memory (DRAM) device included in the communication system of FIG. 3.

FIG. 5 is a block diagram illustrating an example embodiment of the memory core included in the DRAM device of FIG. 4.

FIG. 6 is a block diagram illustrating another example embodiment of the memory core included in the DRAM device of FIG. 4.

FIG. 7 is a block diagram illustrating another example embodiment of the DRAM device included in the communication system of FIG. 3.

FIG. 8 is a block diagram illustrating still another example embodiment of the DRAM device included in the communication system of FIG. 3.

FIG. 9 is a block diagram illustrating a communication system according to another example embodiment of the present invention.

FIG. 10 is a block diagram illustrating an example embodiment of the DRAM device included in the communication system of FIG. 9.

FIG. 11 is a block diagram illustrating another example embodiment of the DRAM device included in the communication system of FIG. 9.

FIG. 12 is a block diagram illustrating still another example embodiment of the DRAM device included in the communication system of FIG. 9.

FIG. 13 is a block diagram illustrating a communication system according to still another example embodiment of the present invention.

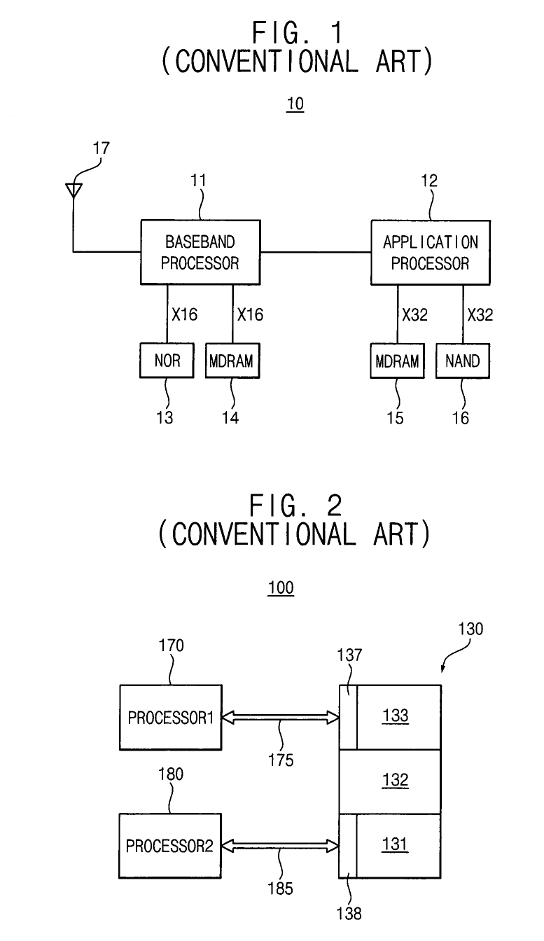

### DESCRIPTION OF THE EMBODIMENTS

Embodiments of the invention now will be described more fully with reference to the accompanying drawings, in which embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

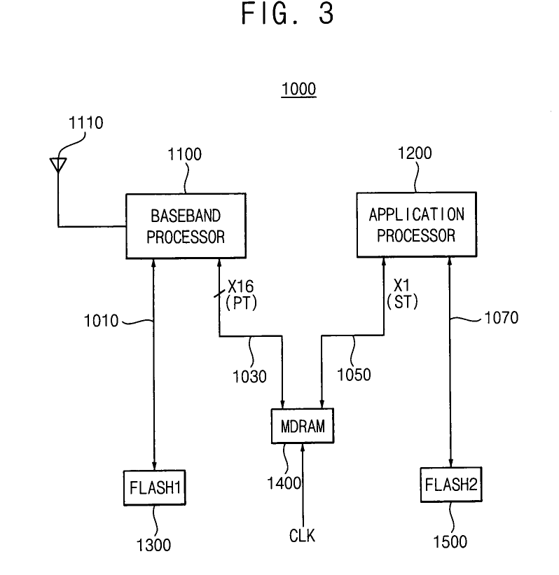

FIG. 3 is a block diagram illustrating a communication system according to an example embodiment of the present invention. A portable communication system 1000 is illustrated in FIG. 3 as an example for convenience of description, but the present invention is not limited to a portable communication system.

Referring to FIG. 3, the portable communication system 1000 includes a baseband processor 1100, an application processor 1200, a first flash memory device 1300, a multi-port memory device 1400, and a second flash memory device 1500. The portable communication system 1000 may include an antenna 1110 connected to the baseband processor 1100. The application processor 1200 may include a device driver (not shown) that controls various input-output (I/O) devices (not shown) and multimedia devices (not shown). The first flash memory device 1300 may be a NOR-type flash memory device and the second flash device 1500 may be a NAND-type flash memory device.

The first flash memory device 1300 is coupled to the baseband processor 1100 via a first bus 1010. The first flash memory device 1300 is exclusively used by the baseband processor 1100. The multi-port memory device 1400 is coupled to the baseband processor 1100 via a second bus 1030 and coupled to the application processor 1200 via a third bus 1050. Based on an external clock signal CLK, the multi-port memory device 1400 generates a first internal clock signal having a first frequency and a second internal clock signal having a second frequency. The multi-port memory device 1400 communicates with the baseband processor 1100 in a parallel interface mode (PT) synchronously with the first internal clock signal and communicates with the application processor 1200 in a serial interface mode (ST) synchronously with the second internal clock signal. The second flash memory device 1500 is coupled to the application processor 1200 via a fourth bus 1070. The second flash memory device 1500 is exclusively used by the application processor 1200.

Hereinafter, an operation of the portable communication system 1000 illustrated in FIG. 3 will be described. The portable communication system 1000 may be a cellular phone, a personal communication system (PCS), or a laptop computer, for example. The baseband processor 1100 processes communication data received through the antenna 1110. The application processor 1200 processes a large amount of data such as pictures and movies and thus requires a mass storage device such as mobile dynamic random access memory (MDRAM) device.

The multi-port memory device 1400 has two ports; one port for communicating with the baseband processor 1100 in the PT through the second bus 1030, and the other port for communicating with the application processor 1200 in the ST through the third bus 1050. The multi-port memory device 1400 interfaces with the baseband processor 1100 with a data bandwidth of X16 and interfaces with the application processor 1200 with a data bandwidth of X1.

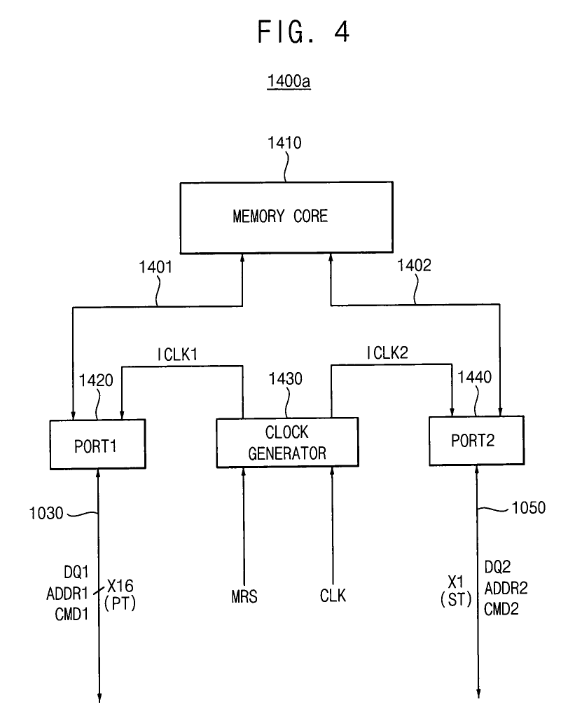

Because the multi-port memory device 1400 communicates with the application processor 1200 in the ST, the second internal clock signal ICLK2 (described below with reference to FIG. 4) may have a higher frequency than the first internal clock signal ICLK1 (described below with reference to FIG. 4). Both of the baseband processor 1100 and the application processor 1200 may access the multi-port memory device 1400 at the same time. For example, while the baseband processor 1100 writes first data to the multi-port memory device 1400, the application processor 1200 may read second data from the multi-port memory device 1400.

When the multi-port memory device 1400 is applied to the portable communication system 1000 as illustrated in FIG. 3, buses and ports between the baseband processor 1100 and the application processor 1200 are not required, and a data transmission speed between the baseband processor 1100 and the application processor 1200 can be increased. Because the multi-port memory device 1400 communicates with the application processor 1200 in the ST, the number of pins for a data transmission may be reduced.

FIG. 4 is a block diagram illustrating an example embodiment of the dynamic random access memory (DRAM) device 1400 included in the communication system of FIG. 3.

Referring to FIG. 4, a DRAM device 1400a includes a memory core 1410, a first port 1420, a clock generator 1430, and a second port 1440.

The clock generator 1430 generates a first internal clock signal ICLK1 and a second internal clock signal ICLK2 based on an external clock signal CLK and a mode register set (MRS) signal.

The first port 1420 is coupled to the memory core 1410 via a sixth bus 1401, and coupled to the baseband processor 1100 in FIG. 3 via the second bus 1030. The second port 1440 is coupled to the memory core 1410 via a seventh bus 1402, and coupled to the application processor 1200 in FIG. 3 via the third bus 1050.

The first port 1420 receives first data from the memory core 1410 and provides the first data to the baseband processor 1100 in FIG. 3 in the PT synchronously with the first internal clock signal ICLK1. For instance, the first port 1420 receives first packet data DQ1/ADDR1/CMD1 from the baseband processor 1100 in FIG. 3 in the PT and provides the first packet data DQ1/ADDR1/CMD1 to the memory core 1410 synchronously with the first internal clock signal ICLK1.

The second port 1440 receives second data from the memory core 1410 and provides the second data to the application processor 1200 in FIG. 3 in the ST synchronously with the second internal clock signal ICLK2, for instance. The second port 1440 receives second packet data DQ2/ADDR2/CMD2 from the application processor 1200 in FIG. 3 in the ST and provides the second packet data DQ2/ADDR2/CMD2 to the memory core 1410 synchronously with the second internal clock signal ICLK2.

Hereinafter, an example operation of the DRAM device 1400a illustrated in FIG. 4 will be described.

The first packet data DQ1/ADDR1/CMD1 includes data DQ1, an address ADDR1, and a command CMD1, and the second packet data DQ2/ADDR2/CMD2 includes data DQ2, an address ADDR2, and a command CMD2.

The clock generator 1430 generates the first internal clock signal ICLK1 and the second internal clock signal ICLK2 based on the external clock signal CLK. The first internal clock signal ICLK1 and the second internal clock signal ICLK2 may have different frequencies. The first port 1420 is for communicating with the baseband processor 1100 in FIG. 3 in the PT synchronously with the first internal clock signal ICLK1. The second port 1440 is for communicating with the application processor 1200 in FIG. 3 in the ST synchronously with the second internal clock signal ICLK2. The frequencies of the internal clock signals may be determined based on the MRS signal to enhance the data transmission speed such that the second internal clock signal ICLK2 may have a higher frequency than the first internal clock signal ICLK1.

The first port 1420 and the second port 1440 may access the memory core 1410 at the same time. For example, when the first port 1410 writes the first data to the memory core 1410, the second port 1440 may read the second data from the memory core 1410.

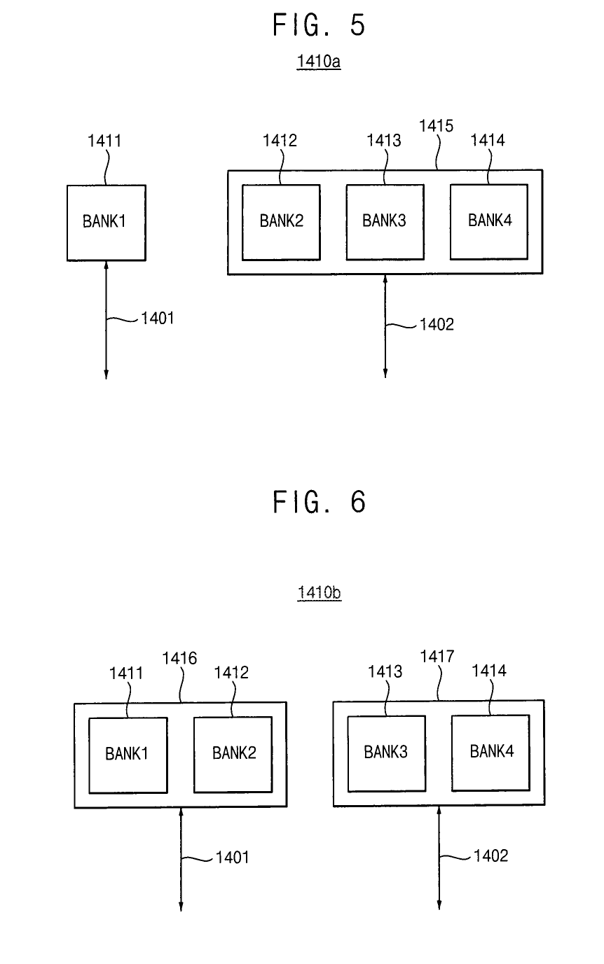

FIG. 5 is a block diagram illustrating an example embodiment of the memory core 1410 included in the DRAM device of FIG. 4.

Referring to FIG. 5, a memory core 1410a includes a first memory bank 1411, a second memory bank 1412, a third memory bank 1413, and a fourth memory bank 1414. The memory core 1410a includes a first part and a second part 1415. The first part is composed of the first memory bank 1411. The second part 1415 is composed of the second memory bank 1412, the third memory bank 1413, and the fourth memory bank 1414. The first part 1411 communicates with the first port 1420 in FIG. 4 through the sixth bus 1401, and the second part 1415 communicates with the second port 1440 in FIG. 4 through the seventh bus 1402.

FIG. 6 is a block diagram illustrating another example embodiment of the memory core 1410 included in the DRAM device of FIG. 4.

Referring to FIG. 6, a memory core 1410b includes a third part 1416 and a fourth part 1417. The third part 1416 is composed of a first memory bank 1411 and a second memory bank 1412. The fourth part 1417 is composed of a third memory bank 1413 and a fourth memory bank 1414. The third part 1416 communicates with the first port 1420 in FIG. 4 through the sixth bus 1401, and the fourth part 1417 communicates with the second port 1440 in FIG. 4 through the seventh bus 1402.

The memory core 1410 of the DRAM device 1400a in FIG. 4 may be divided into two parts as illustrated in FIGS. 5 and 6. One part is accessed by the first port 1420 in FIG. 4 and the other part is accessed by the second port 1440 in FIG. 4. In other embodiments, the memory core 1410b may also be accessed by both of the first port 1420 in FIG. 4 and the second port 1440 in FIG. 4, without being divided into several parts.

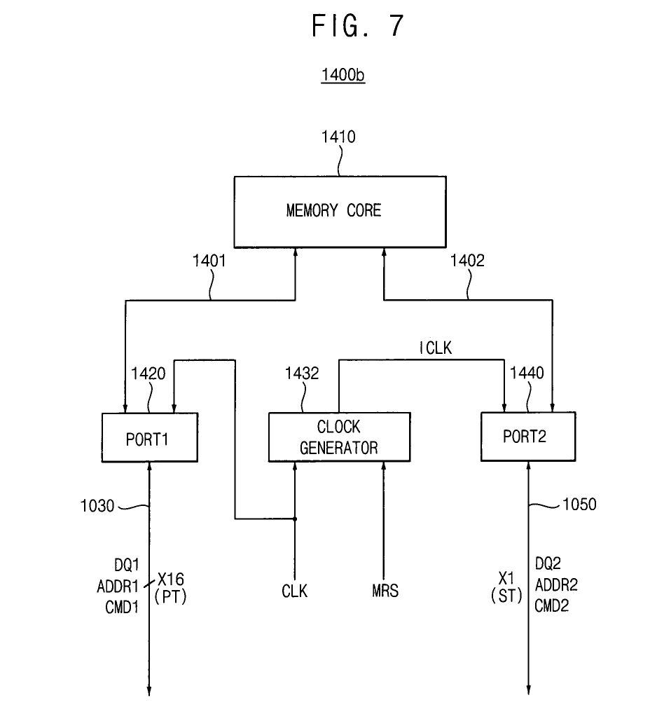

FIG. 7 is a block diagram illustrating another example embodiment of the DRAM device 1400 included in the communication system of FIG. 3.

Referring to FIG. 7, a DRAM device 1400b includes a memory core 1410, a first port 1420, a clock generator 1432, and a second port 1440.

The clock generator 1432 generates an internal clock signal ICLK based on the external clock signal CLK and an MRS signal. The first port 1420 is coupled to the memory core 1410 via the sixth bus 1401 and coupled to the baseband processor 1100 in FIG. 3 via the second bus 1030. The second port 1440 is coupled to the baseband processor 1100 in FIG. 3 via the seventh bus 1402 and coupled to the application processor 1200 in FIG. 3 via the third bus 1050.

The first port 1420 receives first data from the memory core 1410 and provides the first data to the baseband processor 1100 in FIG. 3 in the PT synchronously with the external clock signal CLK. The first port 1420 receives first packet data DQ1/ADDR1/CMD1 from the baseband processor 1100 in FIG. 3 in the PT and provides the first packet data DQ1/ADDR1/CMD1 to the memory core 1410 synchronously with the external clock signal CLK.

The second port 1440 receives second data from the memory core 1410 and provides the second data to the application processor 1200 in FIG. 3 in the ST synchronously with the internal clock signal ICLK. The second port 1440 receives second packet data DQ2/ADDR2/CMD2 from the application processor 1200 in FIG. 3 in the ST and provides the second packet data DQ2/ADDR2/CMD2 to the memory core 1410 synchronously with the internal clock signal ICLK.

In the DRAM device 1400b illustrated in FIG. 7, the first port 1420 communicates with the baseband processor 1100 in FIG. 3 in the PT synchronously with the external clock signal CLK. The second port 1440 communicates with the application processor 1200 in FIG. 3 in the ST synchronously with the internal clock signal ICLK.

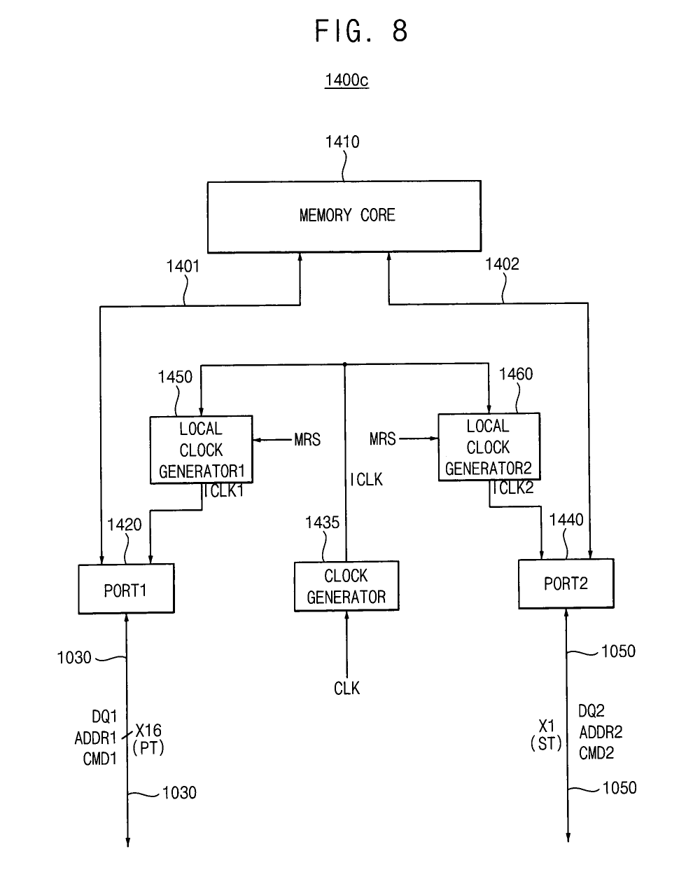

FIG. 8 is a block diagram illustrating still another example embodiment of the DRAM device 1400 included in the communication system of FIG. 3.

Referring to FIG. 8, a DRAM device 1400c includes a memory core 1410, a first port 1420, a clock generator 1435, a second port 1440, a first local clock generator 1450, and a second local clock generator 1460.

The clock generator 1435 generates an internal clock signal ICLK based on the external clock signal CLK. Based on the internal clock signal ICLK and an MRS signal, the first local clock generator 1450 generates a first internal clock signal ICLK1, and the second local clock generator 1460 generates a second internal clock signal ICLK2.

The first port 1420 is coupled to the memory core 1410 via the sixth bus 1401, and coupled to the baseband processor 1100 in FIG. 3 via the second bus 1030. The second port 1440 is coupled to the memory core 1410 via a seventh bus 1402 and coupled to the application processor 1200 in FIG. 3 via the third bus 1050.

The first port 1420 receives first data from the memory core 1410 and provides the first data to the baseband processor 1100 in FIG. 3 in the PT synchronously with the first internal clock signal ICLK1. In addition, the first port 1420 receives first packet data DQ1/ADDR1/CMD1 from the baseband processor 1100 in FIG, 3 in the PT and provides the first packet data DQ1/ADDR1/CMD1 to the memory core 1410 synchronously with the first internal clock signal ICLK1.

The second port 1440 receives second data from the memory core 1410 and provides the second data to the application processor 1200 in FIG. 3 in the ST synchronously with the second internal clock signal ICLK2. The second port 1440 receives second packet data DQ2/ADDR2/CMD2 from the application processor 1200 in FIG. 3 in the ST and provides the second packet data DQ2/ADDR2/CMD2 to the memory core 1410 synchronously with the second internal clock signal ICLK2.

In the DRAM device 1400c of FIG. 8, the clock generator 1435 generates an internal clock signal ICLK based on the external clock signal CLK. The internal clock signal ICLK and the external clock signal CLK may have the same frequency. That is, the clock generator 1435 may be implemented by a buffer. The first local clock generator 1450 generates the first internal clock signal ICLK1 and the second local clock generator 1460 generates the second internal clock signal ICLK2. The first port 1420 communicates with the baseband processor 1100 in FIG. 3 in the PT synchronously with the first internal clock signal ICLK1. The second port 1440 communicates with the application processor 1200 in FIG. 3 in the ST synchronously with the second internal clock signal ICLK2.

The first local clock generator 1450 determines a frequency of the first internal clock signal ICLK1 in response to the MRS signal, and the second local clock generator 1460 determines a frequency of the second internal clock signal ICLK2 in response to the MRS signal.

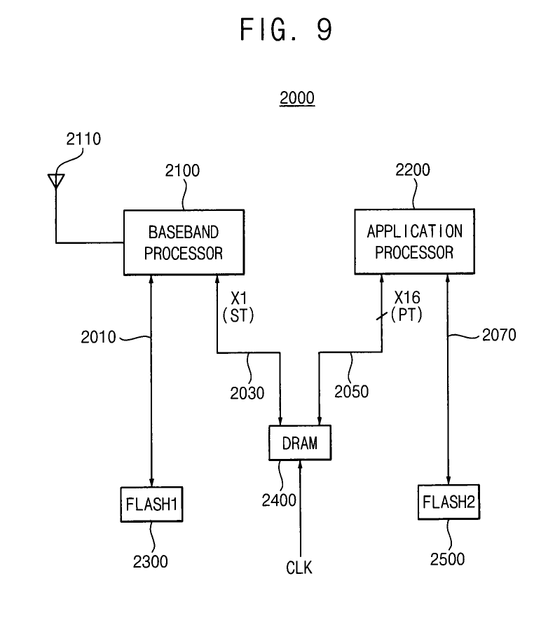

FIG. 9 is a block diagram illustrating a communication system 2000 according to another example embodiment of the present invention.

Referring to FIG. 9, the portable communication system 2000 includes a baseband processor 2100, an application processor 2200, a first flash memory device 2300, a multi-port memory device 2400, and a second flash memory device 2500. The portable communication system 2000 may include an antenna 2110 connected to the baseband processor 2100. The application processor 2200 may include a device driver (not shown) that controls various I/O devices (not shown) and multimedia devices (not shown). The first flash memory device 2300 may be a NOR-type flash memory device and the second flash memory device 2500 may be a NAND-type flash memory device.

The first flash memory device 2300 is coupled to the baseband processor 2100 via a first bus 2010. The first flash memory device 2300 is exclusively used by the baseband processor 2100. The multi-port memory device 2400 is coupled to the baseband processor 2100 via a second bus 2030 and coupled to the application processor 2200 by a third bus 2050. Based on an external clock signal CLK, the multi-port memory device 2400 generates a first internal clock ICLK1 signal having a first frequency and a second internal clock signal ICLK2 having a second frequency. The multi-port memory device 2400 communicates with the baseband processor 2100 in a ST synchronously with the first internal clock signal ICLK1 and the multi-port memory device 2400 communicates with the application processor 2200 in a PT synchronously with the second internal clock signal ICLK2. The second flash memory device 2500 is coupled to the application processor 2200 via a fourth bus 2070. The second flash memory device 2500 is exclusively used by the application processor 2200.

Hereinafter, an operation of the portable communication system 2000 illustrated in FIG. 9 will be described.

The multi-port memory device 2400 has two ports; one port for communicating with the baseband processor 2100 in the ST through the second bus 2030, and the other port for communicating with the application processor 2200 in the PT through the third bus 2050. In the example embodiment of FIG. 9, the multi-port memory device 2400 interfaces with the baseband processor 2100 with a data bandwidth of X1, and interfaces with the application processor 2200 with a data bandwidth of X16.

Because the multi-port memory device 2400 communicates with the baseband processor 2100 in the ST, the first internal clock signal ICLK1 may have a higher frequency than the second internal clock signal ICLK2. Both of the baseband processor 2100 and the application processor 2200 may access the multi-port memory device 2400 at the same time. For example, while the baseband processor 2100 writes first data to the multi-port memory device 2400, the application processor 2200 may read second data from the multi-port memory device.

When the multi-port memory device 2400 is applied to the portable communication system 2000 as illustrated in FIG. 9, the buses and the ports between the baseband processor 2100 and the application processor 2200 are not required, and a data transmission speed between the baseband processor 2100 and the application processor 2200 can be increased. In the portable communication system of FIG. 9, since the multi-port memory device 2400 communicates with the baseband processor 2100 in the ST, the number of pins for data transmission may be reduced.

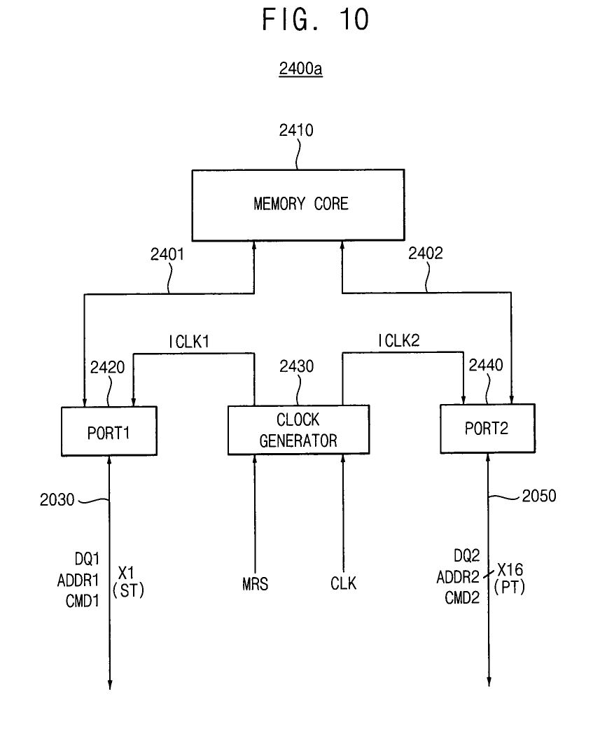

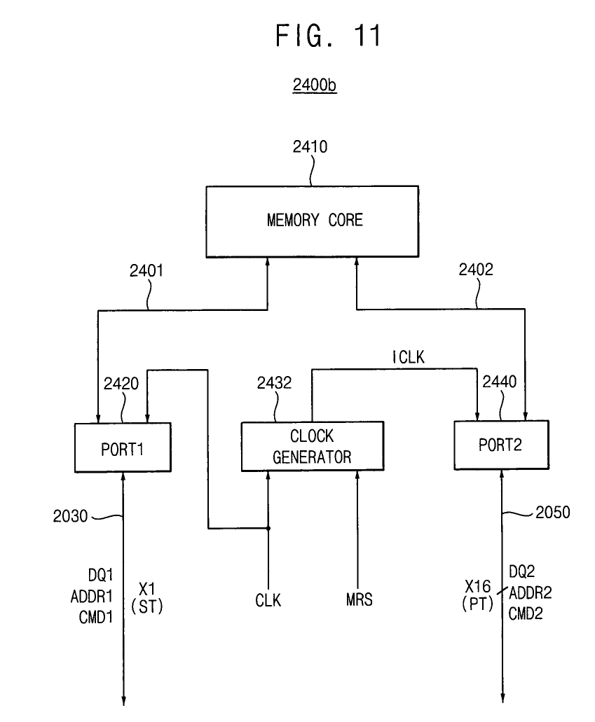

FIG. 10 is a block diagram illustrating an example embodiment of the DRAM device 2400 included in the communication system of FIG. 9.

Referring to FIG. 10, a DRAM device 2400a includes a memory core 2410, a first port 2420, a clock generator 2430, and a second port 2440.

The clock generator 2430 generates a first internal clock signal ICLK1 and a second internal clock signal ICLK2 based on the external clock signal CLK and an MRS signal.

The first port 2420 is coupled to the memory core 2410 via a sixth bus 2401, and coupled to the baseband processor 2100 in FIG. 9 via the second bus 2030. The second port 2440 is coupled to the memory core 2410 via a seventh bus 2402, and coupled to the application processor 2200 in FIG. 9 via the third bus 2050.

The first port 2420 receives first data from the memory core 2410 and provides the first data to the baseband processor 2100 in FIG. 9 in the ST synchronously with the first internal clock signal ICLK1. The first port 2420 receives first packet data DQ1/ADDR1/CMD1 from the baseband processor 2100 in FIG. 9 in the in the ST and provides the first packet data DQ1/ADDR1/CMD1 to the memory core 2410 synchronously with the first internal clock signal ICLK1.

The second port 2440 receives second data from the memory core 2410 and provides the second data to the application processor 2200 in FIG. 9 in the PT synchronously with the second internal clock signal ICLK2. The second port 2440 receives second packet data DQ2/ADDR2/CMD2 from the application processor 2200 in FIG. 9 in the PT and provides the second packet data DQ2/ADDR2/CMD2 to the memory core 2410 synchronously with the second internal clock signal ICLK2.

In the DRAM device 2400a illustrated in FIG. 10, the first port 2420 communicates with the baseband processor 2100 in FIG. 9 in the ST synchronously with the first internal clock signal ICLK1. The second port 2440 communicates with the application processor 2200 in FIG. 9 in the PT synchronously with the second internal clock signal ICLK2. To improve the data transmission speed, the first internal clock signal ICLK1 may have higher frequency than the second internal clock signal ICLK2.

Both of the first port 2420 and the second port 2440 may simultaneously access the memory core 2410. For example, while the first port 2420 writes the first data to the memory core 2410, the second port 2440 may read the second data from the memory core 2410.

FIG. 11 is a block diagram illustrating another example embodiment of the DRAM device 2400 included in the communication system of FIG. 9.

Referring to FIG. 11, a DRAM device 2400b includes a memory core 2410, a first port 2420, a clock generator 2432, and a second port 2440.

The clock generator 2432 generates an internal clock signal ICLK based on the external clock signal CLK and an MRS signal. The first port 2420 is coupled to the memory core 2410 via a sixth bus 2401 and coupled to the baseband processor 2100 in FIG. 9 via the second bus 2030. The second port 2440 is coupled to the memory core 2410 via a seventh bus 2402 and coupled to the application processor 2200 in FIG. 9 via the third bus 2050.

The first port 2420 receives first data from the memory core 2410 and provides the first data to the baseband processor 2100 in FIG. 9 in the ST synchronously with the external clock signal CLK. The first port 2420 receives first packet data DQ1/ADDR1/CMD1 from the baseband processor 2100 in FIG. 9 in the ST and provides the first packet data DQ1/ADDR1/CMD1 to the memory core 2410 synchronously with the external clock signal CLK.

The second port 2440 receives second data from the memory core 2410 and provides the second data to the application processor 2200 in FIG. 9 in the PT synchronously with the internal clock signal ICLK. The second port 2440 receives second packet data DQ2/ADDR2/CMD2 from the application processor 2200 in FIG. 9 in the PT and provides the second packet data DQ2/ADDR2/CMD2 to the memory core 2410 synchronously with the internal clock signal ICLK.

In the DRAM device 2400b illustrated in FIG. 11, the first port 2420 communicates with the baseband processor 2100 in FIG. 9 in the ST synchronously with the external clock signal CLK. The second port 2440 communicates with the application processor 2200 in FIG. 9 in the PT synchronously with the internal clock signal ICLK.

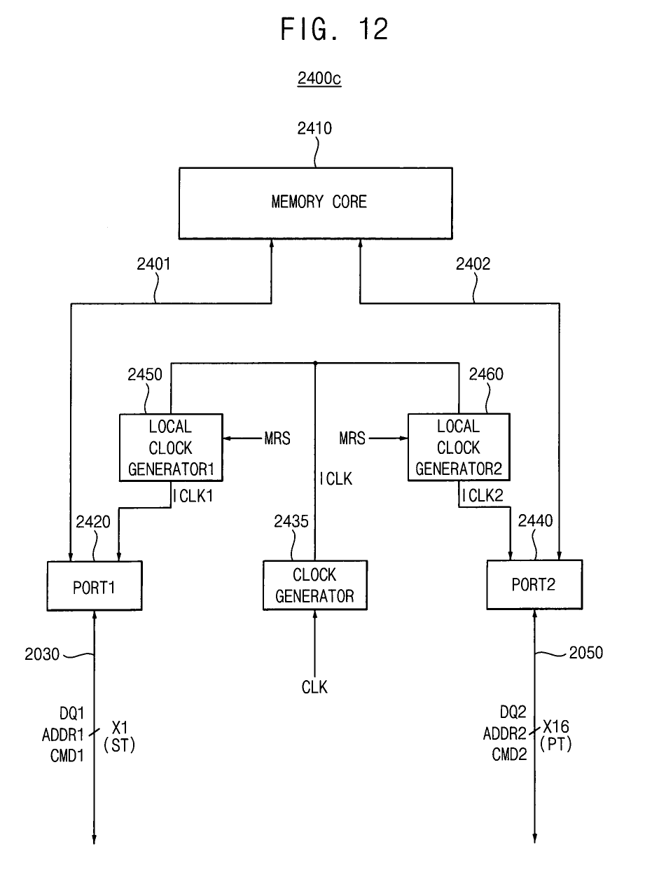

FIG. 12 is a block diagram illustrating still another example embodiment of the DRAM device 2400 included in the communication system of FIG. 9.

Referring to FIG. 12, a DRAM device 2400c includes a memory core 2410, a first port 2420, a clock generator 2435, a second port 2440, a first local clock generator 2450, and a second local clock generator 2460.

The clock generator 2435 generates an internal clock signal ICLK based on the external clock signal CLK. The first local clock generator 2450 generates a first internal clock signal ICLK1 based on the internal clock signal ICLK and an MRS signal. The second local clock generator 2460 generates a second internal clock signal ICLK2 based on the internal clock signal ICLK and the MRS signal.

The first port 2420 is coupled to the memory core 2410 via a sixth bus 2401, and coupled to the baseband processor 2100 in FIG. 9 via the second bus 2030. The second port 2440 is coupled to the memory core 2410 via a seventh bus 2402, and coupled to the application processor 2200 in FIG. 9 via the third bus 2050.

The first port 2420 receives first data from the memory core 2410 and provides the first data to the baseband processor 2100 in FIG. 9 in the ST synchronously with the first internal clock signal ICLK1. The first port 2420 receives first packet data DQ1/ADDR1/CMD1 from the baseband processor 2100 in FIG. 9 in the ST and provides the first packet data DQ1/ADDR1/CMD1 to the memory core 2410 synchronously with the first internal clock signal ICLK1.

The second port 2440 receives second data from the memory core 2410 and provides the second data to the application processor 2200 in FIG. 9 in the PT synchronously with the second internal clock signal ICLK2. The second port 2440 receives second packet data DQ2/ADDR2/CMD2 from the application processor 2200 in FIG. 9 in the PT and provides the second packet data DQ2/ADDR2/CMD2 to the memory core 2410 synchronously with the second internal clock signal ICLK2.

In the DRAM device 2400c of FIG. 12, the clock generator 2435 generates the internal clock signal ICLK based on the external clock signal CLK. The internal clock signal ICLK and the external clock signal CLK may have the same frequency. That is, the clock generator 2435 may be implemented by a buffer. The first local clock generator 2450 generates the first internal clock signal ICLK1 and the second local clock generator 1460 generates the second internal clock signal ICLK2. The first port 2420 communicates with the baseband processor 2100 in FIG. 9 in the ST synchronously with the first internal clock signal ICLK1. The second port 2440 communicates with the application processor 2200 in FIG. 9 in the PT synchronously with the second internal clock signal ICLK2.

The first local clock generator 2450 determines a frequency of the first internal clock signal ICLK1 in response to the MRS signal, and the second local clock generator 2460 determines a frequency of the second internal clock signal ICLK2 in response to the MRS signal.

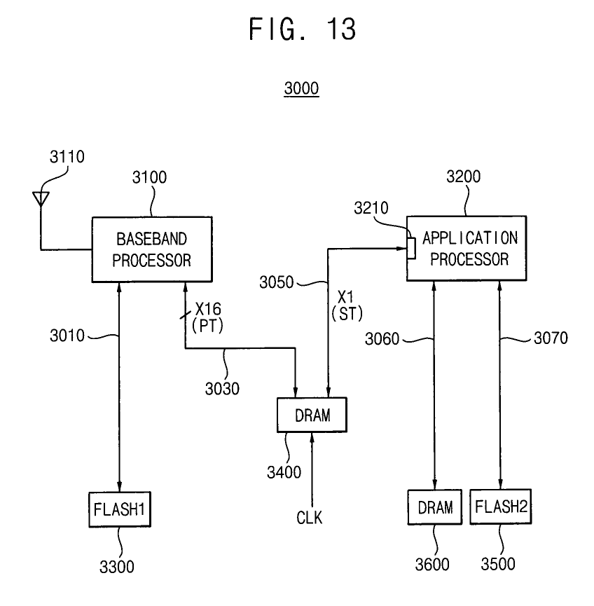

FIG. 13 is a block diagram illustrating a portable communication system 3000 according to still another example embodiment of the present invention.

Referring to FIG. 13, the portable communication system 3000 includes a baseband processor 3100, an application processor 3200, a first flash memory device 3300, a multi-port memory device 3400, a second flash memory device 3500, and a DRAM device 3600. The portable communication system 3000 may include an antenna 3110 connected to the baseband processor 3100. The application processor 3200 may include device drivers (not shown) that control various I/O devices (not shown) and multimedia devices (not shown). The first flash memory device 3300 may be a NOR-type flash memory device and the second flash memory device 3500 may be a NAND-type flash memory device.

The first flash memory device 3300 is coupled to the baseband processor 3100 via a first bus 3010. The first flash memory device 3300 is exclusively used by the baseband processor 3100. The multi-port memory device 3400 is coupled to the baseband processor 3100 via a second bus 3030 and coupled to the application processor 3200 by a third bus 3050. The application processor 3200 communicates with the multi-port memory device 3400 through a port 3210. In a conventional method, the port 3210 equipped in the application processor 3200 is used for communicating with the baseband processor 3100.

The multi-port memory device 3400 generates a first internal clock signal ICLK1 having a first frequency and a second internal clock signal ICLK2 having a second frequency based on an external clock signal CLK. The multi-port memory device 3400 communicates with the baseband processor 3100 in a PT synchronously with the first internal clock signal ICLK1, and communicates with the application processor 3200 in a ST synchronously with the second internal clock signal ICLK2. The second flash memory device 3500 is coupled to the application processor 3200 via a fourth bus 3070. The second flash memory device 3500 is exclusively used by the application processor 3200. The DRAM device 3600 is coupled to the application processor 3200 via a fifth bus 3060 and is used exclusively by the application processor 3200.

Hereinafter, an operation of the portable communication system 3000 illustrated in FIG. 13 will be described.

The multi-port memory device 3400 has two ports; one port for communicating with the baseband processor 3100 in the PT through the second bus 3030, and the other port for communicating with the application processor 3200 in the ST through the third bus 3050. In the example of FIG. 13, the multi-port memory device 3400 interfaces with the baseband processor 3100 with a data bandwidth of X16, and interfaces with the application processor 3200 with a data bandwidth of X1.

As the multi-port memory device 3400 communicates with the baseband processor 3100 in the ST, the second internal clock signal ICLK2 may have a higher frequency than a first internal clock signal ICLK1. Both of the baseband processor 3100 and the application processor 3200 may access the multi-port memory device 3400 at the same time. For example, the application processor 3200 may read first data from the multi-port memory device 3400, while the baseband processor 3100 writes second data to the multi-port memory device 3400.

When the multi-port memory device 3400 is applied to the portable communication system 3000 as illustrated in FIG. 13, the buses and the ports between the baseband processor 3100 and the application processor 3200 are not required, and a data transmission speed between the baseband processor 3100 and the application processor 3200 may be increased. Because the multi-port memory device 3400 communicates with the application processor 3200 in the ST, the number of pins for data transmission may be reduced in the portable communication system of FIG. 13.

According to the present invention, the multi-port memory device and the processors may communicate with each other in different interface modes. The multi-port memory device communicates with the first processor in the ST and communicates with the second processor in the PT. Accordingly, the multi-port memory device of the present invention may reduce the number of pins and manufacturing costs.

While the example embodiments of the invention and their advantages have been described in detail, it should be understood that various changes, substitutions and alterations may be made herein without departing from the scope of the invention.

What is claimed is:

1. A communication system, comprising:
a first processor;
a second processor; and
a multi-port memory device configured to communicate with the first processor in a parallel interface mode synchronously with a first internal clock signal and configured to communicate with the second processor in a serial interface mode synchronously with a second internal clock signal, the multi-port device generating the first internal clock signal and the second internal clock signal based on an external clock signal.

2. The communication system of claim 1, wherein frequencies of the first internal clock signal and the second internal clock signal are determined in response to a mode register set signal.

3. The communication system of claim 1, wherein the second internal clock signal has a frequency higher than a frequency of the first internal clock signal.

4. The communication system of claim 3, wherein the first internal clock signal and the second internal clock signal have substantially the same frequency.

5. The communication system of claim 3, wherein the first processor is a baseband processor and the second processor is an application processor.

6. The communication system of claim 5, wherein the first processor is configured to control communication modems.

7. The communication system of claim 5, wherein the second processor configured to control input-output devices and multimedia devices.

8. The communication system of claim 3, wherein the first processor is an application processor and the second processor is a baseband processor.

9. The communication system of claim 1, wherein the multi-port memory device comprises:
a memory core;
a clock generator configured to generate the first internal clock signal and the second internal clock signal based on the external clock signal;
a first port configured to communicate with the first processor in the parallel interface mode synchronously with the first internal clock signal, the first port receiving first data from the memory core to provide the first data to the first processor and receiving first packet data from the first processor to provide the first packet data to the memory core; and
a second port configured to communicate with the second processor in the serial interface mode synchronously with the second internal clock signal, the second port receiving second data from the memory core to provide the second data to the second processor and receiving second packet data from the second processor to provide the second packet data to the memory core.

10. The communication system of claim 9, wherein the second internal clock signal has a frequency higher than a frequency of the first internal clock signal.

11. The communication system of claim 9, wherein each of the first packet data and the second packet data includes an address, a command, and transfer data.

12. The communication system of claim 9, wherein the memory core comprises:
a first part configured to be exclusively accessed by the first port; and
a second part configured to be exclusively accessed by the second port.

13. The communication system of claim 9, wherein each of the first port and the second port is configured to access an entire range of the memory core.

14. The communication system of claim 1, wherein the multi-port memory device comprises:
a memory core;
a clock generator configured to generate an internal clock signal based on the external clock signal;
a first local clock generator configured to generate the first internal clock signal based on the internal clock signal;
a second local clock generator configured to generate the second internal clock signal based on the internal clock signal;
a first port configured to communicate with the first processor in the parallel interface mode synchronously with the first internal clock signal, the first port receiving first data from the memory core to provide the first data to the first processor and receiving first packet data from the first processor to provide the first packet data to the memory core; and
a second port configured to communicate with the second processor in the serial interface mode synchronously with the second internal clock signal, the second port receiving second data from the memory core to provide the second data to the second processor and receiving second packet data from the second processor to provide the second packet data to the memory core.

15. The communication system of claim 14, wherein the second internal clock signal has a frequency higher than a frequency of the first internal clock signal.

16. The communication system of claim 14, wherein each of the first packet data and the second packet data includes an address, a command, and transfer data.

17. A communication system, comprising:
a first processor;
a second processor;
a memory device configured to be exclusively used by the second processor; and
a multi-port memory device configured to communicate with the first processor in a parallel interface mode synchronously with a first internal clock signal and communicate with the second processor in a serial interface mode synchronously with a second internal clock signal, the first internal clock signal and the second internal clock signal being generated by the multi-port memory device based on an external clock signal.

18. The communication system of claim 17, wherein the second processor is configured to communicate with the multi-port memory device based on modem protocols.

19. The communication system of claim 17, wherein the second internal clock signal has a frequency higher than a frequency of the first internal clock signal.

20. The communication system of claim 17, wherein the first processor is a baseband processor and the second processor is an application processor.

21. The communication system of claim 17, wherein the multi-port memory device comprises:
a memory core;
a clock generator configured to generate the first internal clock signal and the second internal clock signal based on the external clock signal;
a first port configured to communicate with the first processor in the parallel interface mode synchronously with the first internal clock signal, the first port receiving first data from the memory core to provide the first data to the first processor and receiving first packet data from the first processor to provide the first packet data to the memory core; and
a second port configured to communicate with the second processor in the serial interface mode synchronously with the second internal clock signal, the second port receiving second data from the memory core to provide the second data to the second processor and receiving second packet data from the second processor to provide the second packet data to the memory core.

22. A multi-port memory device, comprising:
a memory core;
a clock generator configured to generate a first internal clock signal and a second internal clock signal based on an external clock signal;
a first port configured to communicate in a parallel interface mode synchronously with the first internal clock signal, the first port receiving first data to provide the first data outside the memory device and receiving first packet data from outside the memory device to provide the first packet data to the memory core; and
a second port configured to communicate in a serial interface mode synchronously with the second internal clock signal, the second port receiving second data to provide the second data outside the memory device and receiving second packet data from outside the memory device to provide the second packet data to the memory core.

23. The multi-port memory device of claim 22, wherein the second internal clock signal has a frequency higher than a frequency of the first internal clock signal.

24. The multi-port memory device of claim 22, wherein each of the first packet data and the second packet data includes an address, a command, and transfer data.

25. The multi-port memory device of claim 22, wherein each of the first port and the second port is configured to access an entire range of the memory core.
